(19) United States
(12) Patent Application Publication
(10) Pub. No.: US 2015/0023792 A1
(43) Pub. Date: Jan. 22, 2015

(54) WIND TURBINE ROTOR BLADE DE-ICING PROCESS AND WIND TURBINE ROTOR BLADE DE-ICING SYSTEM

(71) Applicant: ADIOS Patent GmbH i.Gr., Hamburg (DE)

(72) Inventors: Joerg Spitzner, Hamburg (DE); Fabian Timmo Seebo, Hamburg (DE); Robert Mitschke, Hamburg (DE); Ramon Bhatia, Hamburg (DE); Alexander Backs, Hamburg (DE)

(21) Appl. No.: 14/332,549

(22) Filed: Jul. 16, 2014

(30) Foreign Application Priority Data
Jul. 17, 2013 (EP) 13176822.8

(51) Int. Cl. F03D 11/00

(52) U.S. Cl. CPC F03D 11/0025
USPC 416/1; 416/39

(57) ABSTRACT

The invention relates to a wind turbine rotor blade heating process with a wind turbine rotor blade de-icing system arranged on a rotor blade (11), including modular heating elements (210, 211, 212, 213, 214, 220, 221, 222, 223, 230, 231, 232, 24) driven cyclically, recurring, intermittently and/or continuously, wherein at least one modular heating element (210, 211, 212, 213, 214, 220, 221, 222, 223, 230, 231, 232, 24) is provided with a temperature sensor and/or an electric resistance measuring sensor, with which a continuous measurement of the environment measurement values (U) is carried out and the wind turbine rotor blade de-icing system is activated upon reaching predetermined environmental measurement values (U), wherein upon reaching predetermined environment conditions (U), first, a measurement cycle is started, wherein a modular heating element (210, 211, 212, 213, 214, 220, 221, 222, 223, 230, 231, 232, 24) is driven, of which the temperature profile (f=dt (t)) is measured and compared with a heating-element-specific temperature profile without any ice (f0), wherein in the case of a reduced increase in temperature (F1) or the formation of a plateau/holding portion in the course of the temperature rise, the wind turbine rotor blade de-icing system is activated for removal of ice, and in the case that the same rise and/or profile of the temperature (f0), the wind turbine rotor blade de-icing system is not activated.

The invention further relates to a wind turbine rotor blade heating system on a rotor blade (11) of a wind turbine (1).

The invention relates to a wind turbine rotor blade de-icing process with a wind turbine rotor blade de-icing system disposed on a rotor blade, comprising modular electrical heating elements, which are actuated cyclically, recurring, intermittent and/or continuous, wherein at least one modular heating element is provided with a temperature sensor and/or electrical resistance sensor, whereby environmental values are measured continuously and the wind turbine rotor blade de-icing system is activated upon reaching predetermined environmental measured values.

The invention further relates to a wind turbine rotor blade heating system on a rotor blade of a wind turbine, including at least two heating zones with modular heating elements, wherein the modular heating elements are controllably activated cyclically and/or continuously, a control system for the activation of individual heating zones, main heating elements and/or auxiliary heating elements, environmental-, proximity-, rain-, temperature- and/or atmospheric humidity-sensors for detection of control variables, wherein evaluation of the sensors is performed by the control system.

Different arrangements and methods are known from the state of the art in order to de-ice wind turbine rotor blades or keep them ice-free.

From EP 1017580 B1 a de-icing and anti-icing system for a wing of an aircraft is known, wherein a laminate in the form of a three-layer structure with a heat-conducting layer is used, and this is present as a flexible sheet of expanded graphite, wherein different heat layer thicknesses lead to different heating power. The appropriate modules start to heat up when an icing sensor reports a possible icing upon the occurrence of specific icing conditions, namely a combination of ambient temperature, humidity and dew point. In this regard, there is also a monitoring of the temperature of the heating elements, whereby the input of energy is controlled.

Also known from EP 1846293 B1 is a heating system with different heating zones, wherein in this case the heating zones are activated cyclically to remove forming ice.

Furthermore, from EP 1541467 B1 a system employable for maintaining aerodynamic surfaces ice-free with flexible heating modules is known, including a flexible medium, heating elements, a microprocessor, and a temperature and icing sensor. The corresponding modules begin to heat up when the respective associated ice sensors report icing and the temperature sensors fall below a threshold.

The problem of the risk of icing or the icing of wind turbine rotor blades is of increasing importance nowadays, since through the development of new sites, more and more wind farms are being built in locations liable to icing conditions.

Due to ice formation, damage can occur to the plant due to imbalance, which leads to a significant shortening of the lifetime of a wind turbine. There is also the risk of throwing off ice, wherein flight distances can be up to 250 m, which is why it is mandatory that the systems in the present state must be shut for icing. Another problem of ice formation results from the loss of income due to ice-dependent shutdowns which can amount to 20% of the annual energy yield per year.

The current state of the art ice sensors do not work reliably by far and all too often signal an ice warning much too early, so that the wind turbine must be shut down too early.

With ever larger rotor diameters it occurs more often that the outer portions of the rotor blades already immerse in the clouds, in which icing conditions already exist, whereas no ice conditions are detectable on the ice sensor, which has always been positioned in the prior art in the area of the nacelle.

The problem with the de-icing systems known in the art thus concerns the generally bad or wrong controlled response relationship since often ice conditions are present that are not detectable on environmental measurement sensors on the nacelle. Furthermore, the high energy consumption of the known prior art de-icing system of a wind turbine rotor blade is a negative economic aspect.

An object of the present invention is to provide a wind turbine rotor blade de-icing process as well as a wind turbine rotor blade de-icing system, which ensures an energy-efficient de-icing, a reliable ice detection at very low aerodynamic penalty and without significant additional load or drag.

This object is achieved with a wind turbine rotor blade de-icing process according to the main claim and a wind turbine rotor blade de-icing system according to the related independent claim.

According to the invention, upon reaching a predetermined environmental condition, first, a measurement cycle is started wherein a modular heating element is driven, the temperature curve (f=dt (t)) is measured and compared with an ice-free heating-element-specific temperature curve (ft)), wherein in the case of reduced rise in temperature or the formation of a plateau/holding area in the course of the temperature rise, the wind turbine rotor blade de-icing system is activated for removal of ice, and in the case of the same increase and/or variation of the temperature, the wind turbine rotor blade de-icing system is not activated.

After the heating element is energized, heating occurs due to the electrical resistance, whereupon the heat is transferred to the outside of the rotor blade surface. In the case that no ice is present, a heating takes place in accordance with a specific heater temperature curve which is almost similar for most environmental conditions. In the case that ice is present on the rotor blade surface, first a part of the heat energy is used for melting of the ice, so that a different temperature curve with a plateau, or, instead of the temperature measurement, during the measurement cycle, the electric resistance is measured as a control variable, and the resistance profile is compared with a heater-specific resistance curve without any ice. Analogous to the course of the temperature, here also plateaus or holding portions are identifiable in the resistance curve. These plateaus or holding areas arise due to the melting of existing ice above the heating element so that it can be interpreted as a clear indication that ice is present. If no ice is present, then the measured resistance response curve and the heater element characteristic resistivity profile curve are almost identical.

On the whole, therefore, the possibility arises to perform an ice detection directly on the wind turbine rotor blade by means of the heating elements in conjunction with a temperature sensor or a resistance sensor, wherein this can be done reliably and with energy saving almost anywhere on the rotor blade without aerodynamic interference and without significant additional loads.

The measured values from environmental-, ambient-, rain-, temperature- and/or humidity-sensors can be collected and used to verify the achievement of specified environmental conditions. In this case, the sensors can may be attached or arranged on nacelle, on the tower and/or the rotor blade itself, wherein, in the case of attachment to the rotor blade, the sensors are preferably provided at the rotor blade tip.

Next, a database is created and/or revised plant-specific during operation of the wind turbine, wherein in this database the environmental conditions can be stored, which may have been present during a measurement cycle in the case of icing. In this way, a plant-specific icing profile is realized or refined, so that a corresponding measurement cycle can be started much more precisely by reference to the environmental conditions.

Upon achievement of environmental conditions that are associated with stored ice detection in the database, the activation of the wind turbine rotor blade de-icing system will already take place during the execution of the measurement cycle. In the absence of detection of ice during the measuring cycle, the environment conditions associated with existing ice captured in the database are corrected and there is an immediate shutdown of the wind turbine rotor blade de-icing system.

Upon activation of the wind turbine rotor blade de-icing, first, auxiliary heating elements of the heating zones arranged around a large surface area heater are activated. Here, the ice formed on the auxiliary heating elements is initially melted, resulting in smaller ice patches on the main heating elements.

After activation of the auxiliary heater elements, the main heating elements are activated, so that the ice will be melted by the main heating elements and thrown off by the centrifugal force. As these ice sheets have only a small area, they pose no danger to the environment. Since the size of the ice sheets are designed to be smaller on the main heating elements, they can be released from these much easier.

The auxiliary heating elements remain continuously active as long as ice is detected during a measurement cycle.

The main heating elements are cyclically or intermittently active as long as the auxiliary heating elements are activated.

The measurement cycle is carried out on a small heating element or a heating element at the blade tip, whereby ice may be detected at an early stage, in particular during emersion of the rotor blade tip in the ice cloud.

Further, all heating elements may be provided with a corresponding ice sensor, wherein, starting from the blade tip, the heating elements are activated in sequence. Here, the next further inwardly located heating element is activated only when the previously activated more externally disposed heating element actually detects ice. In this way the complete de-icing system does not have to be activated, but rather only segmentally is activated.

In the case of sectional ice detection, these values can also be stored in a database, allowing the system to work more efficiently.

The controller of the system thus regulates when each heating element heats, for how long and at what power. The heating time and the power supplied is determined based on various parameters such as the outside temperature, the wind speed and the air humidity and the like, in combination with a specific map of the heating elements.

With regard to the system, the wind turbine rotor blade heating system on a rotor blade of a wind turbine includes least two heating zones with modular heating elements, wherein the modular heating elements are actuatable cyclically and/or continuously, a control system for activating individual heating zones, main heating elements and/or auxiliary heating elements, environmental-, proximity-, rain-, temperature- and/or atmospheric humidity-sensors for detection of control variables, wherein evaluation of the sensors is performed by the control system, wherein one large surface-area main heater is provided per heating zone, and auxiliary heaters are arranged around this main heater.

The heating zones or the individual heating panels are arranged such that they are present only in the region of the stagnation point. There are thus large heating zones consisting of a main heater, which is discontinuous and/or cyclically controlled, and auxiliary heating elements that are continuously driven.

The auxiliary heating elements completely surround/encircle the main heater element. In the area of the auxiliary heating elements no ice formation is allowed.

A heating element preferably provided on the blade tip is provided in a sensor heating zone.

The heating zones are formed flat so as not to negatively impair the aerodynamics. All leads are fed through holes, which are located at a non-critical position, so that the structure of the wind turbine rotor blade is not compromised. The contacting of the individual heating elements is effected in a preferred embodiment by flat metal strips.

The auxiliary heating elements and/or the main heating elements are positioned, bonded or laminated near or at the rotor blade surface.

The main and/or auxiliary heating elements are comprised of a heating enamel with graphite, carbon in micro-and/or nano-structures.

The auxiliary and/or main heating elements are covered with a lightning protection mesh, the lightning protection mesh is connected to the existing grounding of the existing lightning protection system, whereby the resistance of the heating-element lightning-protection mesh is preferably low, but for the actual lightning protection, the wind turbine still remains the preferred lightning target.

The structure of the heating system is as follows: On the rotor blade surface the heating material is applied by means of a carrier film, and this is then covered with an insulating film and the lightning protection mesh. Then, the sealing is done with an anti-erosion protection film.

The environmental-, proximity-, rain-, temperature- and/or atmospheric humidity-sensors are arranged on the wind turbine nacelle, on the wind turbine tower, on the wind turbine rotor blade and/or at the tip of the wind turbine rotor blade.

The data to be transmitted from sensors can be preferably transmitted via a radio link. The energy transfer is preferably carried out by slip rings in the hub.

For the production of the de-icing system, this can be pre-manufactured, wherein single-sided adhesive sheets having a heating enamel layer and copper strips for the contact are provided, which are then adhered with double-sided adhesive film with the lightning protection mesh on one side and the heating enamel on the other side. Finally, an erosion protection film is provided on the heating foils as a sacrificial layer, which is preferably applied only when mounted on the rotor blade.

Installation can be carried out either at the factory or later on the hanging rotor blade. To be applied on the rotor blade, the prefabricated de-icing system, divided in the spanwise direction into a plurality of sections, is adhered onto the rotor blade. The contact strips are directed to a hole in the blade, where they are connected to respective internal conductive cables that lead to the rotor blade hub.

In the following, exemplary embodiments of the invention will be described in detail with reference to the accompanying drawings.

In the drawings:

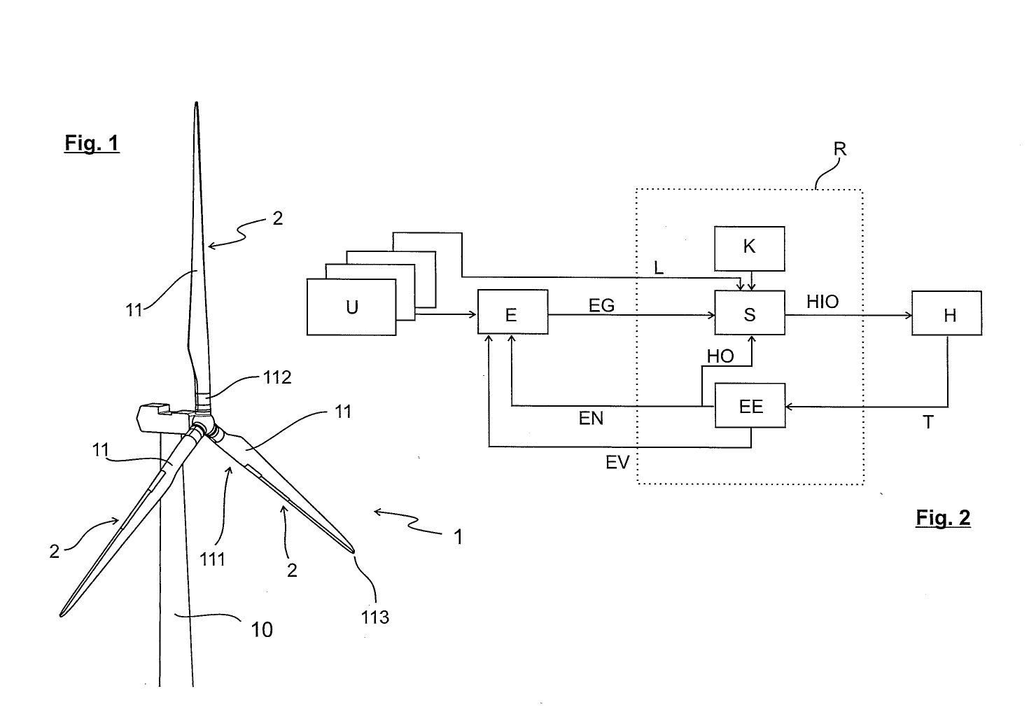

FIG. 1 is a schematic representation of a wind energy plant with three blades, at the front edge of which a heating system is arranged for de-icing;

FIG. 2 is a schematic illustration of the regulation and control of a heating system;

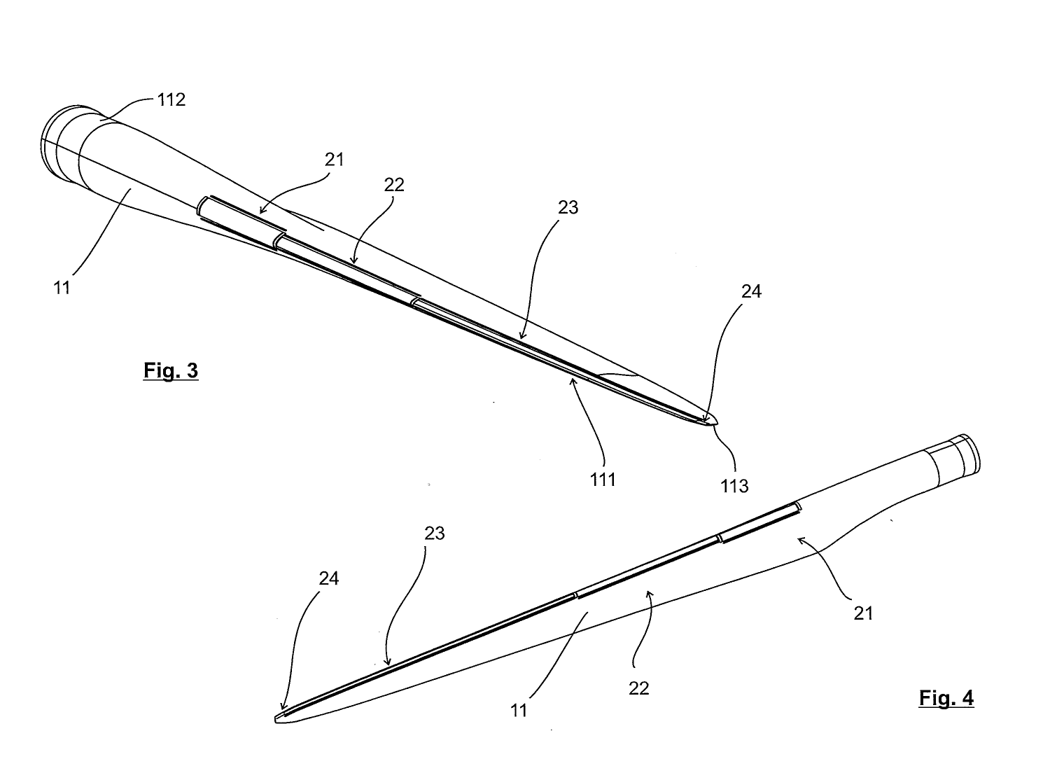

FIGS. 3 and 4 are schematic representations of two views of a rotor blade with the heating system;

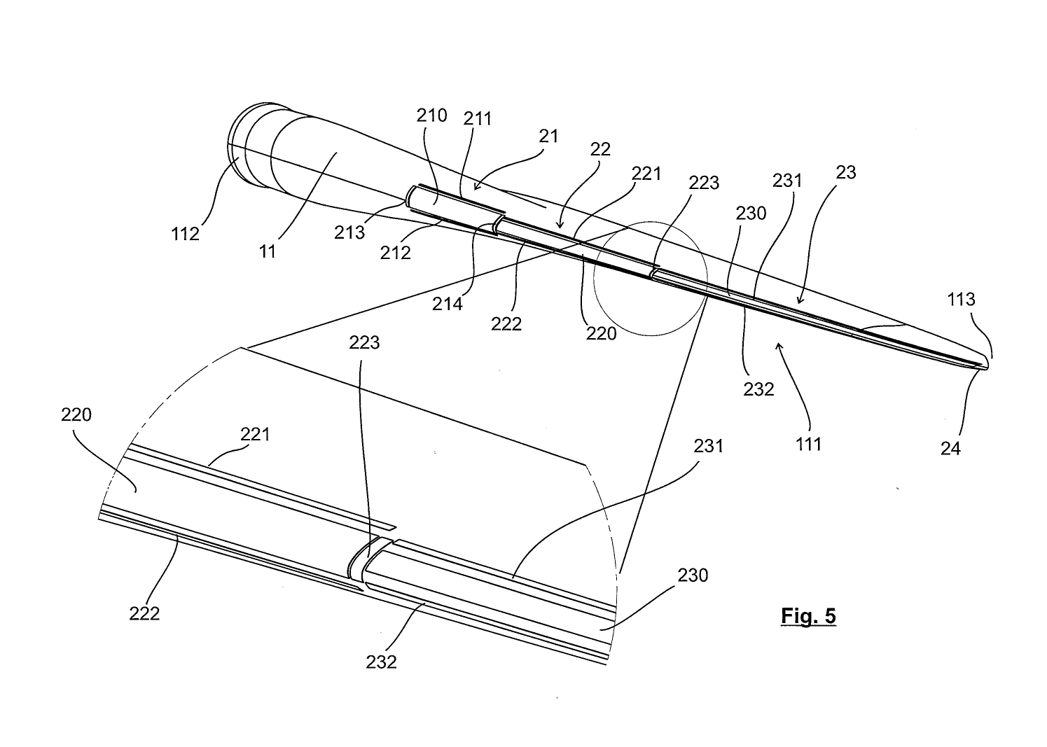

FIG. 5 is a schematic representation of the heating system on a rotor blade, wherein a partial section is shown enlarged to better illustrate the invention, and

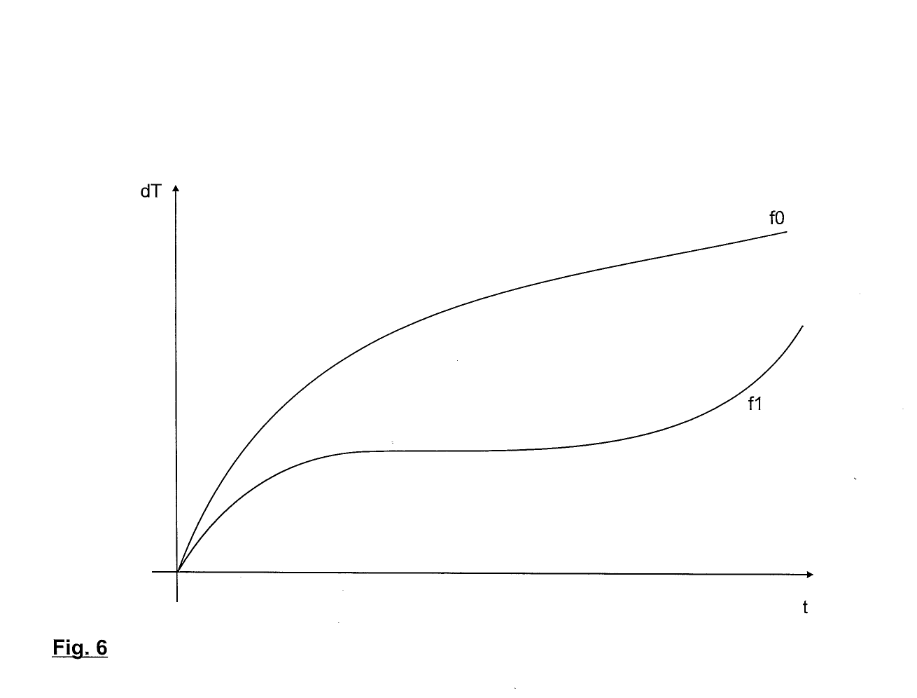

FIG. 6 is a graph of the change in temperature over time for a temperature sensor of a heating element with and without ice.

FIG. 1 shows a schematic representation of a wind turbine 1 comprising a tower with a nacelle arranged on it, on which the three rotor blades 11 are arranged, wherein at the leading edge 111 a heating system 2 is arranged for de-icing.

In the critical areas of the rotor blade, in which icing is generally possible, individual electric heating elements are arranged along the longitudinal extension of the rotor blade 11 which, as necessary, remove ice from the surface of the rotor blade 11 or maintain the blade free of ice.

In the following, the same reference numerals as used in FIG. 1 are used for like elements. For the basic principle of functioning or operation reference is made to FIG. 1.

FIG. 2 shows a schematic representation of the regulation R and control S for a heating system 2.

Here, a cognitive ice prediction and ice detection is realized. Different parameters, namely, the environmental factors / environmental values U, such as temperature, humidity, dew point, wind speed, and the like are collected and combined to form an overall picture, wherein these readings with a corresponding recognition of presence of ice signal EV, or in the case of no ice present, signal negative feedback EN, so that on the basis of these measurements a forecast for the presence of ice is issued.

The cognitive ice prognosis E is adaptive because it can detect similarities or patterns and thus for slight deviations in weather U can nevertheless respond correctly with an ice forecast. In similar overall situations ice is predicted, whereby feedback is reported as to whether ice is actually present. In the case of ice danger a positive feedback EC takes place; if no ice is present, there is the negative feedback EN. The test, as to whether ice is present or not, occurs via the ice detection EE, which detects the temperature history T or dT of the heating elements H and analyzes this.

The control S of the heating fields H includes, besides the commands switch-on and switch-off HIO to the heating panels, also when to turn on, when each heating element heats, for how long, and at what power. The heating duration and power L supplied is determined and regulated on the basis of the environmental influences U and a performance map or characteristic diagram K.

Should it be determined, after the start of the heating system H, that the ice prognosis was wrong, whereupon this is recognized by the ice detection BE, there occurs the signal to switch off the heating panels HO, so that all the heating panels are deactivated.

FIGS. 3 and 4 are schematic illustrations of a rotor blade 11 in two views with the heating system 2 at the leading edge 111. Starting from the receptacle of the rotor blade 112 three heating zones, namely, a first heating zone 21, a second heating zone 22 and a third heating zone 23, are arranged. At the tip of the blade 112 sensor heat element 24 is additionally provided, which merely heats only a very small surface.

FIG. 5 shows a schematic representation of the heating system 2 on a rotor blade 11, with a section shown enlarged for better illustration of the invention. In this illustration, the details of the heating system 2 are shown.

For a better understanding of the heating system, the details of the heating system 2 are shown in this figure. The heating system 2 is comprised, as in FIGS. 3 and 4, of the three heating zones 21, 22, 23, which represent a preferred embodiment. An embodiment with only one 21, two 21, 22, heating zones is however also possible, and depends on the length of the rotor blade 11. Of course, more than three heating zones are possible.

Each heating zone 21, 22, 23 consists of a main heating element 210, 220, 230, which is surrounded by a plurality of auxiliary heating elements.

The first heating zone 21 thus comprises the first main heating element 210, which is bordered by a first upper auxiliary heating element 211 on the upper side, bordered by a first lower auxiliary heating element 212 on the underside, bordered by a starting assist heating element 213 on the side of the rotor blade receptacle 113, and bordered by a first intermediate assist heating element 214 which also borders the next adjacent main heater 220.

The second heating zone 22 thus comprises the second main heating element 220, which is bordered by a second upper auxiliary heating element 221 on the upper side, bordered by a second lower auxiliary heating element 222 on the underside, bordered by the first intermediate assist heating element 214 on the side of the rotor blade receptacle 113 and the first main heater 210, and bordered by a second intermediate assist heating element 223 next to the adjacent main heater 230.

The third heating zone 23 thus comprises the third main heating element 230, which is bordered by a third upper auxiliary heating element 231 on the upper side, bordered by a third lower auxiliary heating element 232 on the underside, the second intermediate assist heating element 223 on the side of the rotor blade receptacle 113 and towards the second main heating element 220, and is bordered by a sensor heating element 24 or, alternatively, a third, not shown here intermediate assist heating element.

At the blade tip 113, the sensor heating element 24 is located in the sensor heating zone 24. This sensor heating element 24 is preferably controlled to execute the measurement cycle described. The measurement cycle is started when the appropriately environmental conditions are present and a detection for the presence of ice or a checking of the ice prognosis is to be performed.

The auxiliary heating elements 211, 212, 213, 214, 221, 222, 223, 231, 232 which surround the main heaters 210, 220, 230 are shown separately in this figure, this being one possible configuration, preferred is however the complete circumscribing arrangement of the auxiliary heating elements.

The auxiliary heating elements 211, 212, 213, 214, 221, 222, 223, 231, 232 are continuously electrically driven in the case of risk of icing, so that no ice can form in this area. The main heating elements, however, are activated cyclically so as to remove, by melting, ice formed on the surface.

FIG. 6 is a graph showing the temperature change dT in a time profile for a temperature sensor of a heating element 210, 211, 212, 213, 214, 220, 221, 222, 223, 230, 231, 232, 24 with ice f1 and without ice f0.

The upper curve ID represents the time profile of the temperature without the ice on the surface of the heating element, the lower curve f1 represents the time profile of the temperature with ice on the surface of the heating element, wherein the ice after some time t upon reaching a certain temperature T begins to melt, for which energy is required, and this energy extraction causes a change in the temperature increase dT in the heating element. A holding stage or plateau is formed, in which period the electric energy is diverted to melting off the ice and is not used for heating the heating element itself.

Alternatively to monitoring the temperature, in analogous manner the resistance of the electrical heating element can be detected and compared with a specific resistance characteristic curve similar to the temperature comparison, so as to thereby perform an ice detection. The ice detection is thus a check on energy consumption caused by change in state of frozen water from solid to liquid or gaseous form.

### LIST OF REFERENCE NUMERALS

1 wind turbine

10 tower

11 rotor blade

111 front edge

112 blade tip

113 blade receptacle

2 heating system

21 first heating zone

210 first main heating element

211 first upper auxiliary heating element

212 first lower auxiliary heating element

213 starting assist heating element

214 first intermediate auxiliary heating element

22 second heating zone

220 second main heating element

221 second upper auxiliary heating element

222 second lower auxiliary heating element

223 second intermediate auxiliary heating element

23 third heating zone

230 third main heating element

231 third upper auxiliary heating element

232 lower third auxiliary heating element

24 sensor heating zone, sensor heating element

EE ice detection

EC risk of icing, positive feedback

EN no ice present, negative feedback

EV ice present

E cognitive ice prognosis

f0 function of the temperature over time without ice

f1 function of the temperature over time with ice

H heating panels (heating elements of the heating system)

HIO heater panels switched on or off

HO signal to switch off the heating panels

K map

L determines the power

R regulation

S control

t time

dT temperature change

T temperature profile

U environmental influence, environmental measurement value, environmental conditions

1. A wind turbine rotor blade de-icing process with a wind turbine rotor blade de-icing system provided on a rotor blade (11), comprising modular electrical heating elements (210, 211, 212, 213, 214, 220, 221, 222, 223, 230, 231, 232, 24), which are driven cyclically, recurring, intermittent and/or continuously, wherein at least one modular heating element (210, 211, 212, 213, 214, 220, 221, 222, 223, 230, 231, 232, 24) is provided with a temperature sensor and/or electrical resistance measuring sensor, the process comprising
carrying out a continuous measurement of environmental data (U) and
activating the wind turbine rotor blade de-icing system upon attaining predetermined environmental measurements (U),
wherein
upon attaining a predetermined environment condition (U), first, a measurement cycle is started, in which a modular heating element (210, 211, 212, 213, 214, 220, 221, 222, 223, 230, 231, 232, 24) is driven, of which the temperature profile (f=dt (t)) is measured and compared with a heating-element-specific temperature profile without any ice (f0), and
in the case of a reduced temperature rise (fl) or the formation of a plateau/holding portion in the course of temperature rise, the wind turbine rotor blade de-icing system is activated for removal of ice, and
in the case of an increase and/or variation of the temperature corresponding to the heating-element-specific temperature profile without any ice (f0) the wind turbine rotor blade de-icing system is not activated.

2. The wind turbine rotor blade de-icing process according to claim 1, wherein during the measuring cycle, instead of the temperature (T), the electrical resistance is measured as a control variable, wherein the resistance profile is compared with a heating element-specific resistance profile without any ice.

3. The wind turbine rotor blade de-icing process according to claim 1, wherein measurements of environmental-, proximity-, rain-, temperature- and/or atmospheric humidity-sensors are recorded and are used to verify the attaining of predetermined environmental conditions (U).

4. The wind turbine rotor blade de-icing process according to claim 1, wherein during operation a device-specific database is created and/or revised, wherein in this database the environmental conditions (U) are stored, which existed in the case of the detection of ice during a measurement cycle.

5. The wind turbine rotor blade de-icing process according to claim 3, wherein upon reaching environmental conditions (U), which are already associated with an ice detection in the database, an activation of the wind turbine rotor blade de-icing system occurs already during the performance of the measuring cycle.

6. The wind turbine rotor blade de-icing process according to claim 4, wherein in the case of non-detection of ice during the measuring cycle, the environment conditions (U) associated with existing ice stored in the database is corrected and an immediate shutdown of the wind turbine rotor blade de-icing system occurs.

7. The wind turbine rotor blade de-icing process according to claim 1, wherein upon activation of the wind turbine rotor blade de-icing system first the auxiliary heating elements (211, 212, 213, 214, 221, 222, 223, 231, 232) around the large-area main heating element (210, 220, 230) of the heating zones (21, 22, 23 , 24) are activated.

8. The wind turbine rotor blade de-icing process according to claim 6, wherein
after activation of the auxiliary heating elements (211, 212, 213, 214, 221, 222, 223, 231, 232) an activation of the main heating elements (210, 220, 230) takes place.

9. The wind turbine rotor blade de-icing process according to claim 6, wherein the auxiliary heating elements (211, 212, 213, 214, 221, 222, 223, 231, 232) remain activated continuously as long ice is detected during a measurement cycle.

10. The wind turbine rotor blade de-icing process according to claim 7, wherein the main heating elements (210, 220, 230) are activated cyclically or intermittently as long as the auxiliary heating elements (211, 212, 213, 214, 221, 222, 223, 231, 232) are activated.

11. The wind turbine rotor blade de-icing process according to claim 1, wherein the measuring cycle is carried out on a small heating element (211, 212, 213, 214, 221, 222, 223, 231, 232) or a heating element (24, 230, 231, 232) on the blade tip (113).

12. A wind turbine rotor blade heating system on a rotor blade (11) of a wind turbine (1) comprising at least two heating zones (21, 22, 23) with modular heating elements (210, 211, 212, 213, 214, 220, 221, 222, 223, 230, 231, 232, 24), wherein the modular heating elements (210, 211, 212, 213, 214, 220, 221, 222, 223, 230, 231, 232, 24) are driveable periodically and/or continuously,
a drive system for activating individual heating zones (21, 22, 23), the main heating elements (210, 220, 230) and/or auxiliary heating elements (211, 212, 213, 214, 221, 222, 223, 231, 232), environmental-, proximity-, rain-, temperature- and/or atmospheric humidity-sensors for detecting control parameters, which sensors are evaluated by the control system, wherein one large-area main heating element (210, 220, 230) is provided per heating zone, wherein around this main heating element (210, 220, 230) the auxiliary heating elements (211, 212, 213, 214, 221, 222, 223, 231, 232) are arranged.

13. The wind turbine rotor blade heating system according to claim 12, wherein the main heating element (210, 220, 230) is driveable discontinuously and/or cyclically and the auxiliary heating elements (211, 212, 213, 214, 221, 222, 223, 231, 232) are continuously driveable.

14. The wind turbine rotor blade heating system according to claim 12, wherein the auxiliary heating elements (211, 212, 213, 214, 221, 222, 223, 231, 232) completely surround/enclosing the main heating element (210, 220, 230).

15. The wind turbine rotor blade heating system according to claim 12, wherein a heating element (24) is provided in a sensor heat zone, preferably on the blade tip.
